(19) United States
(12) Patent Application Publication
(10) Pub. No.: US 2017/0243278 A1
(43) Pub. Date: Aug. 24, 2017

(54) GENERATION OF SUGGESTIONS AND REASONING FOR PRODUCT SELECTION

(71) Applicant: CapitalRock LLC, North Salt Lake, UT (US)

(72) Inventors: John C. Hyde, North Salt Lake, UT (US); Brian L. Hendricks, Kaysville, UT (US)

(73) Assignee: CapitalRock LLC, North Salt Lake, UT (US)

(21) Appl. No.: 15/376,331

(22) Filed: Dec. 12, 2016

Related U.S. Application Data
(63) Continuation-in-part of application No. 13/951,097, filed on Jul. 25, 2013.
(60) Provisional application No. 61/675,689, filed on Jul. 25, 2012.

(51) Int. Cl. G06Q 30/06; G06N 5/04

(52) U.S. Cl. CPC G06Q 30/0631; G06N 5/04

(57) ABSTRACT

A system includes a suggestion component configured to determine a suggestion for a financial product based on one or more client info parameters. The system includes a reason component configured to automatically generate reasoning for the financial product based on the one or more client info parameters, wherein the reasoning provides an explanation for why the financial product provides a benefit to the client based on the one or more client parameters. The system includes a transaction component configured to receive an indication of a transaction or enrollment of the client in the financial product. The system includes a record component configured to store a record of the transaction or enrollment of the financial product with the reasoning.

### CROSS-REFERENCE TO RELATED APPLICATIONS

This application claims priority to U.S. patent application Ser. No. 13/951,097, filed Jul. 25, 2013, titled “NEEDS-BASED SUGGESTION ENGINE” which claims priority from U.S. Patent Provisional Application No. 61/675,689, filed Jul. 25, 2012, titled “NEEDS-BASED SUGGESTION ENGINE,” both of which are hereby incorporated by reference herein in their entirety.

### TECHNICAL FIELD

The present disclosure relates to reasons for product selection and more particularly relates to providing and recording reasons for why a product may benefit a client.

### BRIEF DESCRIPTION OF THE DRAWINGS

A description of example embodiments will be rendered by reference to the appended drawings. It is appreciated that these drawings depict only example embodiments and are therefore not to be considered limiting of its scope. The embodiments will be described and explained with additional specificity and detail through the use of the accompanying drawings in which:

FIG. 1 is a schematic diagram illustrating an embodiment of the function of a needs based suggestion;

FIGS. 2A through 2J illustrate examples of outputs of the needs-based suggestion engine;

FIG. 3 shows an example of an electronic message that may be sent to a financial agent;

FIG. 4 is a flow chart which illustrates a method according to an alternative embodiment;

FIG. 5 is a schematic diagram illustrating an example system for generating and storing reasons or benefits in relation to an investment or financial product;

FIG. 6 is a schematic block diagram illustrating components of a suggestion system, according to one embodiment;

FIG. 7 is a schematic flow chart diagram illustrating a method for logging a transaction or suggestion related to a financial product, according to one embodiment; and

FIG. 8 is a schematic block diagram illustrating a computing system, according to one embodiment

FIG. 9 illustrates a graphed scoring profile, according to one example;

FIG. 10 illustrates a graphed scoring profile showing parameters or values that control the scoring profile, according to one example; and

FIG. 11 illustrates scores from a settings page, according to one example.

### DETAILED DESCRIPTION

The new Department of Labor (DoL) Fiduciary Rule requires that an advisor act in the best interest of a client when recommending retirement solutions, such as annuities. The final version of the DoL Fiduciary rule will require a best interest contract for the sale of both variable and fixed indexed annuities in qualified accounts. If an annuity sale also has commission, a best interest contract exemption (BICE) will also be required. In order to comply, advisors will have to evaluate the client's needs and determine what annuities best meet the client's objectives. Given the dozens of carriers and hundreds of products selecting an annuity product for a client that meets the new regulation can be a daunting task.

Applicants have recognized that the increased requirements highlight the need for firms to provide their advisors tools that analyze products, such as annuities, and suggest those products that are best for their clients. In light of the foregoing, Applicants have developed systems, methods, and devices for determining suggestions, providing reasons a client may need a product, and improving tracking, monitoring, and reporting of investment advice or consulting. The teaching and embodiments disclosed herein may be used improve compliance or to prove compliance with the new fiduciary rule or otherwise track the reasons for the purchase or enrollment in a financial product or plan.

According to one embodiment, a system includes a suggestion component configured to determine a suggestion for a financial product based on one or more client info parameters. The system includes a reason component configured to automatically generate reasons or benefits for the financial product based on the one or more client info parameters, wherein the reasoning provides an explanation for why the financial product provides a benefit to the client based on the one or more client parameters. The system includes a transaction component configured to receive an indication of a transaction or enrollment of the client in the financial product. The system includes a record component configured to store a record of the transaction or enrollment of the financial product with the reasoning.

Applicants disclose herein a sales intelligence engine to determine the relevance of specific products for a client's needs and objectives. In one embodiment, the system gathers key information from clients about their preferences for income, liquidity, time horizon, source of funds (qualified assets), risk tolerance, expenses, and guarantees. The engine may filters an inventory of available products, such as annuities and living benefit options, and then rank those that best meet the client's objectives. When a suggestion is made to a client or when a transaction is performed for a client, a record of the suggestion or transaction may be stored with reasoning automatically generated by the system.

A detailed description of systems and methods consistent with embodiments of the present disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for the purpose of clarity, certain technical material that is known in the related art has not been described in detail in order to avoid unnecessarily obscuring the disclosure.

Some embodiments described herein relate to systems and methods for identifying needs-based financial planning suggestions for users (e.g., clients and potential clients). The system may include a suggestion engine that generates and prioritizes the suggestions. The suggestions may be made directly to a user when the user logs in to a financial services website or access company information through a website. The suggestions may be present as a component of the website and/or may be presented to a financial services professional that then communicates with the user. The design of the system thus enables the suggestions to be explained and communicated directly to the user.

Such users of financial services firms are looking for their firm to provide personalized financial advice and recommendations on their financial needs and priorities through online interactions. The system is designed to either take current customer and product information from a current data management system or collect customer and product information and analyze the information and score, rank and explain the top financial priorities that the user ought to focus on. When the user clicks on a suggestion in the system a description of why that particular suggestion may be relevant to the user is explained in user specific reasoning that includes demographic and product information, client specific calculations and other relevant facts that explain the suggestions to the user as part of this reasoning.

In contrast, conventional systems use more of a “black box” approach which does not provide client specific reasons and calculations that explain why suggestions may be a good fit for a given customer or prospect. Rather, such systems typically generate a list of candidates for a marketing campaign, banner ad or a direct mail campaign.

The systems and methods described herein provide a unique and novel way of providing client specific suggestions to the user complete with all the detailed reasons and calculations of why the suggestion or recommendation may be relevant to the user. It is not enough to identify a suggestion or recommendation to a client or prospect. Most people don't act on financial decisions until they understand why they are important and how the analysis was done, therefore using detailed reasoning to explain to the client why a particular suggestion makes sense and is relevant may be important to success. The systems and methods described herein take a unique approach to the process and provide client specific reasons and calculations that educate the client and therefore will produce higher level of acceptance and results.

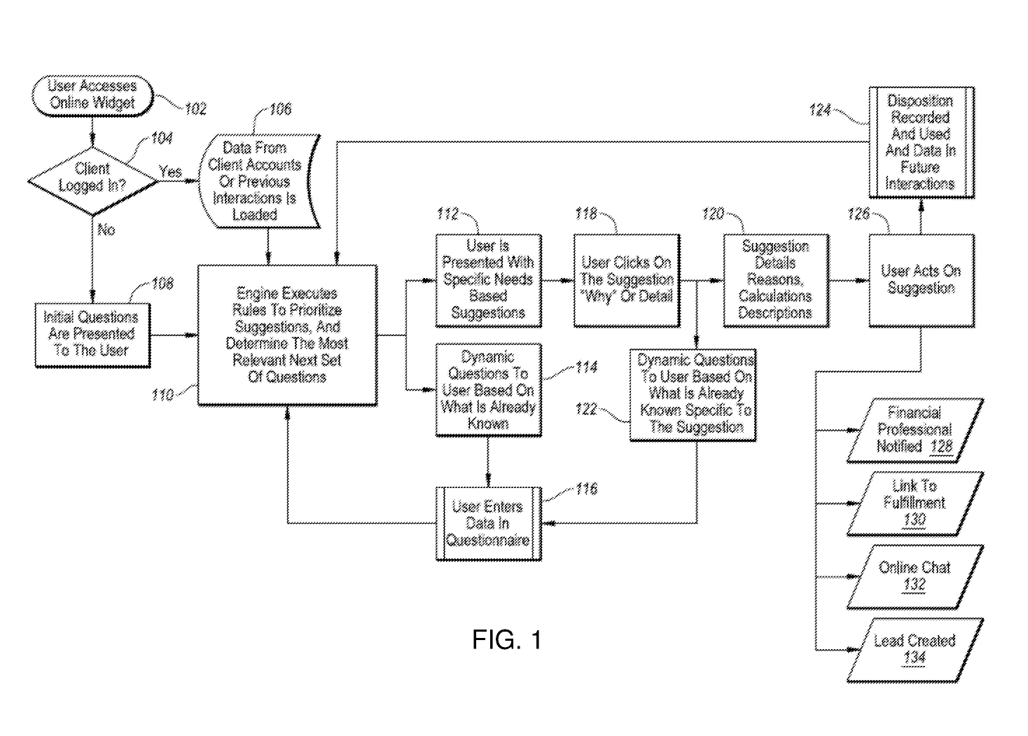

FIG. 1 is a schematic diagram illustrating an embodiment of a system to provide at least one suggestion specific to a user (e.g., a client or prospective client), arranged in accordance with at least some embodiments described herein. When implemented at least partially in software, the system may include a computing device or suggestion engine having a processor and a memory configured to execute computer instructions stored in the memory to cause the computing device or suggestion engine to perform the operations described herein. The suggestions may be based on information collected from the user, or alternatively or in addition to, information obtained from the user's account on a website, such as a client's website. The system may also provide reasons or details pertaining to the suggestion, which may be referred to herein as “reasoning” and may also store the user's actions and generate electronic messages or alerts which may be transmitted to a financial professional.

As shown in FIG. 1, at 102 the user may access the system through an online widget, which may be a software application installed and executed within a web page by the user. For example, the web page of a client, such as an insurance company, financial advisor, bank or the like.

As a non-limiting example, the user may have an account with the client such that the client may login in to the web site at 104. Once the client has logged in, data from the account or from the user's previous interactions with the web site may be loaded at 106. The account data is loaded into the system from existing client information systems using a data warehouse, or client management system.

As another non-limiting example, at 108 one or more initial questions may be presented to the user. The initial questions may be presented to the user via an interface displayed within the website or on a separate web page or pop up launched from the web site. The interface may present the questions in a format that enables the user to easily provide a response. For example, the user may utilize a mouse or touch screen to select sliders, buttons and/or check boxes to provide their response to each of the questions. The initial questions prompted by the system may be, for example, income, age, marital status and number of dependents.

At 110, the answers to the initial or preliminary questions are analyzed and based on these the input of these initial questions calculations will be completed and the recommendation engine may execute rules and prioritize a series of preliminary suggestions which may be presented to the user at 112. Additionally, the recommendation engine may generate an additional list of questions related to specific suggestions being made by the system and present them to the client at 114. The subsequent questions are dynamic and are determined by the responses to the initial questions. For example, if it is determined that a user that is elderly by the initial questions, the user will not be asked questions about funding their own college, but rather may be asked questions related to long-term care insurance, life insurance, medical insurance, health care insurance and the like.

At 116, as the user continues to enter data and answer the dynamic questions, the recommendation engine may continually update the recommendations at 112 and ask additional dynamic questions at 114.

The system may analyze all or at least a portion of available information, including the user's account information and the responses provided by the user to identify key data that is used to rank and score suggestions. Suggestions are scored based on multiple factors that may include, for example, demographics, age, income, marital status, account sizes, existing holdings, number and ages of dependents, types of investment holdings including assets classes, policy types, qualified vs. non-qualified assets, previous interaction data including other suggestions accepted and rejected and/or indications of recent life events (e.g., marriage, job change, death, etc.). This is also coupled with user preference information that may be gathered such as attitudes about risk and flexibility. Such suggestions may include, for example, insurance and financial products and services. By way of example and not limitation, the suggestions may include retirement plans, managed accounts, long term care insurance, wills and trusts, tax planning, insured retirement income, insurance review, alternative investments, home equity line, asset allocation, mortgage refinance, annuities, and the like. Additionally, the suggestions may be service or marketing-oriented suggestions that would suggest the user use other parts of the website such as planning tools, links to other marketing material and the like.

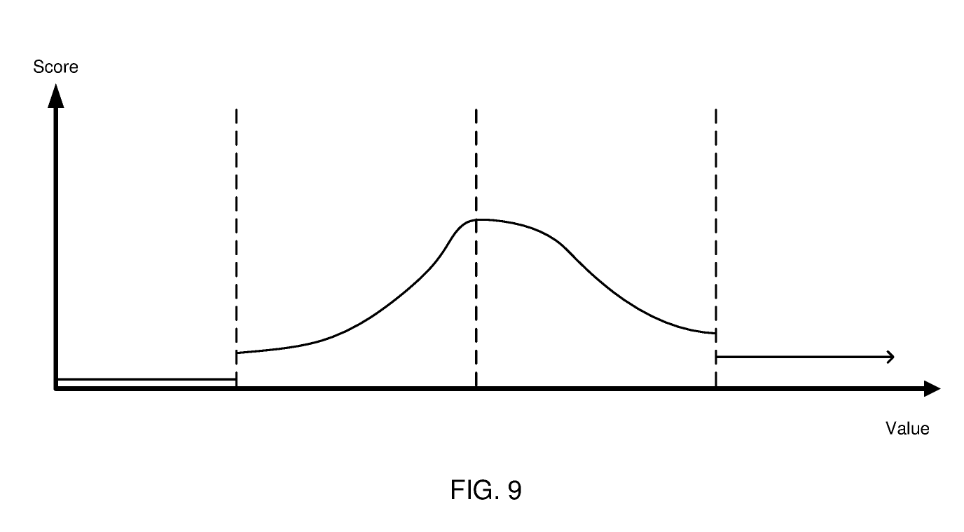

For example, the system may execute one or more rules to generate and/or prioritize the suggestions. Each rule may not be deterministic, but may contribute to or reduce the relevance of a suggestion. This scoring process creates a dynamic priority rather a simple decision tree process. Rules may be applied with different scoring to multiple suggestions. For example, the age of the client may dictate a certain amount to be added or subtracted from a score. For many of the scoring factors, curve scoring rules are used. This is a scoring approach that allows the score to gradually change as a user value changes. This is used where the user value can vary widely and “bracketing” the value does not accurately reflect the change in relevance. This may be the situation for age, income, assets, percent of insurance need filled and the like. A graphed scoring profile may be generated that reflects the results of the scoring process. For example, the graphed scoring profile may look like a modified normal distribution. An example of the graphed scoring profile is shown in FIG. 9 wherein, for each of the points on the horizontal “x” axis, there is a parameter that controls the scoring profile. These parameter/values are as follows:
Left Extreme score: The score for all values less than the left value.
Left Value: The target value on the left. Typically this is the lowest value acceptable scoring. In the case of income, it would be the lowest income acceptable for the bridge. Anything less may not be suitable.
Left Score: The starting score for the left value.
Left Curve Factor: Controls the shape of the curve. These are positive values. The larger the number the greater the “spike” near the midpoint. A lower number would be a gradual increase to the midpoint.
Mid Value: The value at the midpoint. This is used in some cases as the “peak” or so-called “sweet spot.” In others it is a reference point on the way to the extreme.
Mid Score: The score at the midpoint.
Right Value: The top end value. This is used sometimes as the maximum recommended value or in others it is a target.
Right Score: The score at the right value.
Right Curve Factor: Controlling value of the right side curve. See left curve factor.
Right Extreme Score: Score beyond the right value.

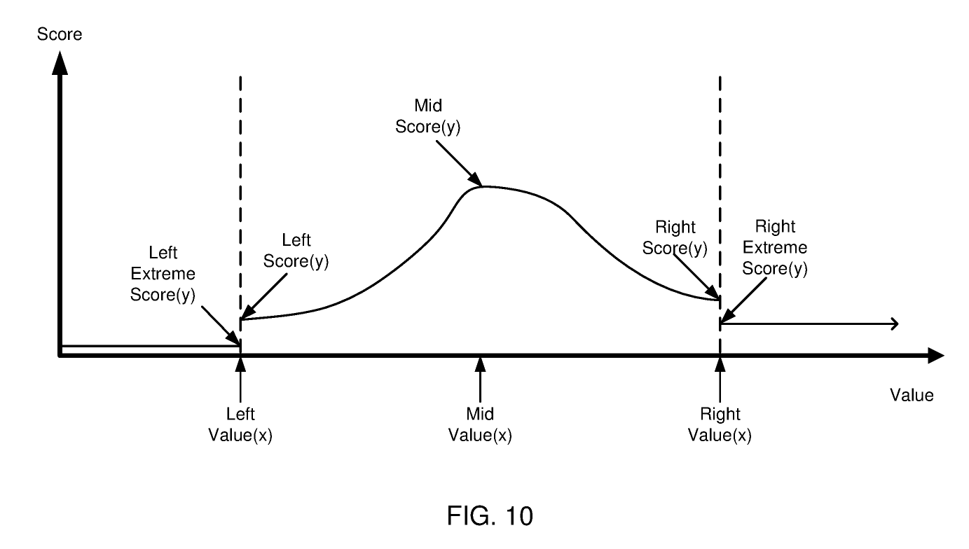

These parameter/values are illustrated on the graphed scoring profile shown in FIG. 10.

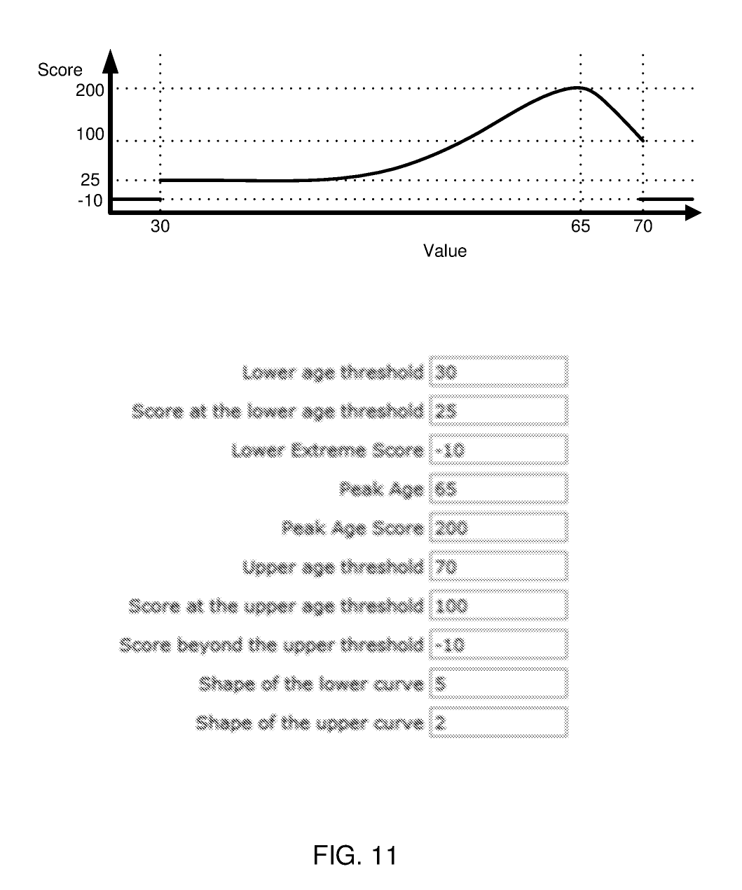

A settings page may be generated that includes scores correlating with the graphed scoring profile. Some examples of scores from the settings page are shown in FIG. 11. In FIG. 11, the peak age is age 65 and lower and upper threshold ages are respectively 30 and 70. Therefore, for ages less than 30 or over 70 the bridge is no longer relevant.

Life insurance shortfall is scored with a mid at 75% of insurance need met. The illustrated assumption is that, until the client has 75% of the recommended insurance, it is equally relevant. From 75% to 100%, it becomes decreasingly less relevant. Other rules may be more static, but each rule is combined with a relative score that applies to the relevance of the suggestion.

The suggestions may then be presented to the user at 112 or a relevant set of dynamic questions may be determined and presented to the user at 114 in order to obtain additional key data. For example, the relevant set of questions may include dynamic questions generated based on previously known information (e.g., the user's account information and the responses provided by the user). The system may prompt the user to add or update the key data. The dynamic questions may be configured to obtain information about the key data to do more in-depth analysis of needs specific to the user. Such data points may include age, change in marital status, purchasing a new home, having/adopting a child and changing jobs.

The information may be analyzed to determine the most relevant questions based on previous input. The relevant set of questions may be presented to the user via the interface, for example. A predetermined number of questions, such as one (1) through five (5) questions may be provided to the user at one time and the user may then be provided with updated results as a reward or incentive to provide the additional data prior to asking additional questions.

When complete information is not available, rule of thumb calculations may be used to generate the suggestions. The rule of thumb calculations may include any calculations now known or later developed. For example, rule of thumb calculations may be used when completing an analysis of a client's life insurance needs. As a non-limiting example, the rule of thumb calculations may be an industry specific rule of thumb that uses a multiple of the client's income based on a client's age, marital status and number of dependents to determine the total need without requiring the detailed capture of all of the client's assets and liabilities. The system automates and uses these multiples to generate reasoning and identify the relevance of opportunities. To assess retirement needs, the rule of thumb may be to replace a certain percentage of income in retirement. Current assets are projected using a future value and compared to current income.

For example, the system may collect information about new life events and may then re-score the suggestions based on the new information entered driving real-time cross selling opportunities.

In embodiments in which the system includes a widget embedded into a client facing website, the widget may be deployed in two ways: (1) at account login; and (2) at a consumer website. In embodiments in which the widget is launched when the user logs in to the client website, the widget may use the account information, which may include prepopulated data, to generate the suggestions. For example, the client website may be configured to allow the account login to get personal data from the account or pull data from personal financial management software.

In embodiments in which the widget is launched at a consumer website, the widget may be launched within the website and may provide questions to obtain the key data using a webpage of the website as the interface.

As is described more fully below, each of the suggestions may be presented with a ranking and accompanying text. The ranking may be presented to the user via a numbering or star system, for example, wherein a higher number indicates a higher priority or vice versa. The accompanying text may provide the user with a detailed explanation of the suggestions as well as the reason the suggestion was made to the client at 118.

Rather than merely restating the logic executed by the recommendation engine or providing a justifying statement, the detailed description may include client specific information and calculations at 120. This detailed description may include narrative explaining accepted financial practice and how it relates to the client specifically based on what is known about the client. The detailed description may contain hyperlinks to other resources or tools such as information libraries and other planning tools. Further the elements of the detailed description may be ranked or displayed according to their effect on the relevance of each suggestion. For example, the detailed description elements may have a contributing relevance score to the overall suggestion relevance score, both positive and negative. In this configuration, each scoring factor will provide a snippet of reasoning or explanation.

Further, a single piece of information supplied by the user may be used in a variety of different calculations for a variety of different scoring methods. For example, a client's age may be used for a variety of different factors and may lead to multiple suggestions, each of which may have a unique detailed description at 120.

Additionally, at 122 the text may include specific questions related to each suggestion, the user's response to which may enable reordering of the suggestions based on the user's priorities. For example, a life events indicated by the user in response to the specific questions may be used to update the suggestions.

At 126, the user may then act on the suggestion. For example, the user may be provided with a link to a financial professional, a request to have a financial professional follow up on the suggestion, or to an application for an insurance product, an enrollment process for financial product, access to online chat session, an offer to send more detailed product information, or an option to decline the suggestion and receive additional relevant suggestions. A simple action may be to link to another part of the website.

The suggestions may be transmitted to a financial professional at 128 using, for example, an electronic message generated by the system. The user may be linked with the financial professional at 130 via an online chat 132 or instant messaging service enabling the user to obtain additional information about the suggestions or to obtain a product and the financial planner to establish a lead to a potential client at 134.

At 124, the disposition of the user may be recorded and used as data in future interactions. The disposition may include one or more of the following: no thanks/not interested, I like it/follow up with me later, contact my financial professional, send me more information, etc.

One of the biggest obstacles to overcome when selling financial products is helping potential clients prioritize and understand their financial needs. The system enables current and potential clients to walk through a straight-forward process to understand what they ought to be focused on and why, thus creating qualified opportunities. Rules driven intelligence may be used to identify and communicate personalized suggestions based on the individual clients needs, and not only based on propensity models of what type of clients has bought the product in the past or the product-of-the-month. Thus, the system enhances the customer experience by providing needs-based product suggestions directly to the customer or prospect.

The system provides a unique online customer experience, personalized client specific suggestions to guide customers through the process and easy to understand reasons why each suggestion is recommended for the user. The system takes a proactive needs based approach that improves loyalty and retention, leverages e-commerce and data warehousing investments and captures life events which influence the suggestions made by the system. The system may also generate and transmit alerts for follow-up complete with suggestion details and user data. The system, thus, enables consistent needs-based suggestions across an entire client-base and user-base.

The computing system may include the following parts: database, suggestion engine, context handler, web server, user interface (UI) render engine. The database holds loaded customer data, data collected from the customer, results of scoring and dispositions. The suggestion engine, ingests data, executes functions and calculations, applies scores and ranks suggestions. The suggestion engine also provides the triggers for additional questions. The context handler applies the appropriate reasoning and suggestion content based on where the request is coming from. Contexts could be different languages, and different users. The web server supports the web components that include the UI render engine. The UI render engine accepts question triggers from the engine and builds the input pages on the web dynamically personalizing the experience.

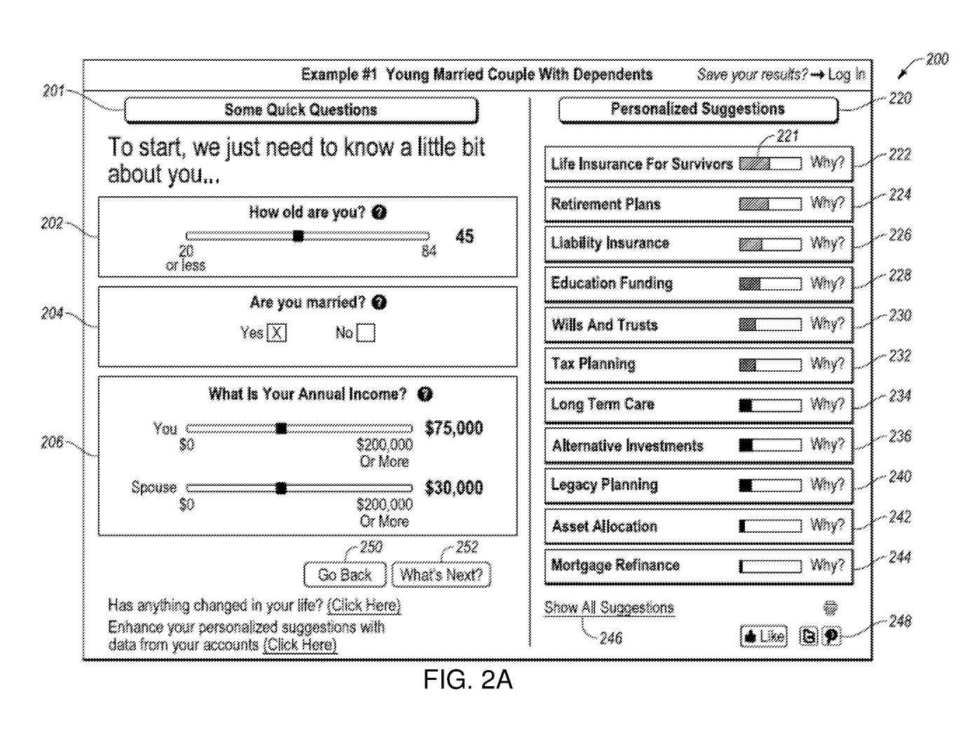

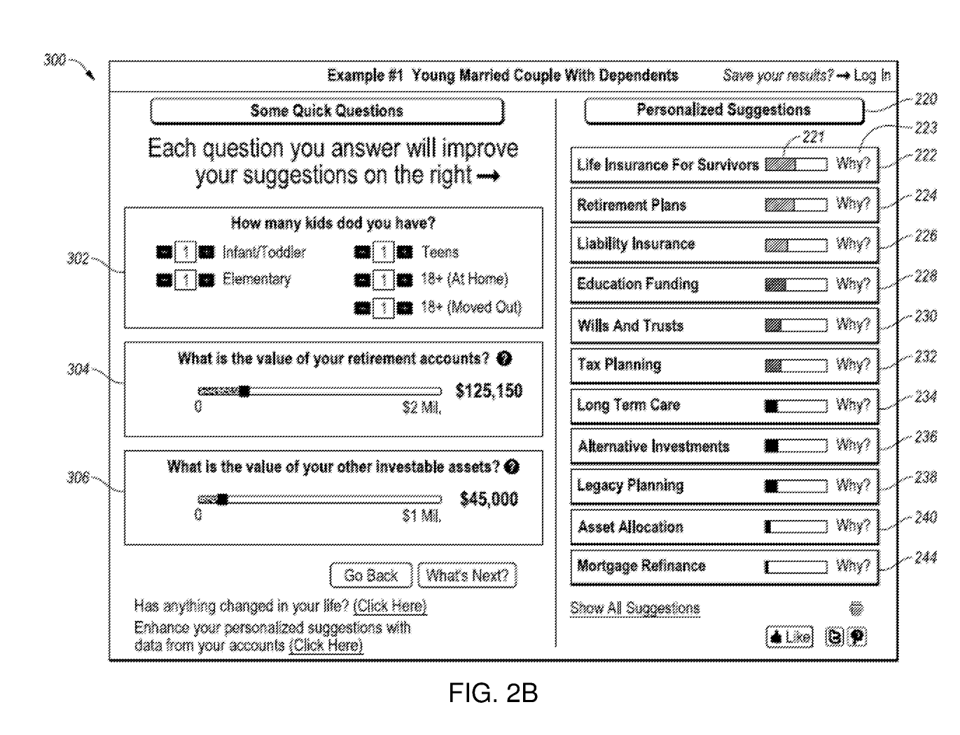

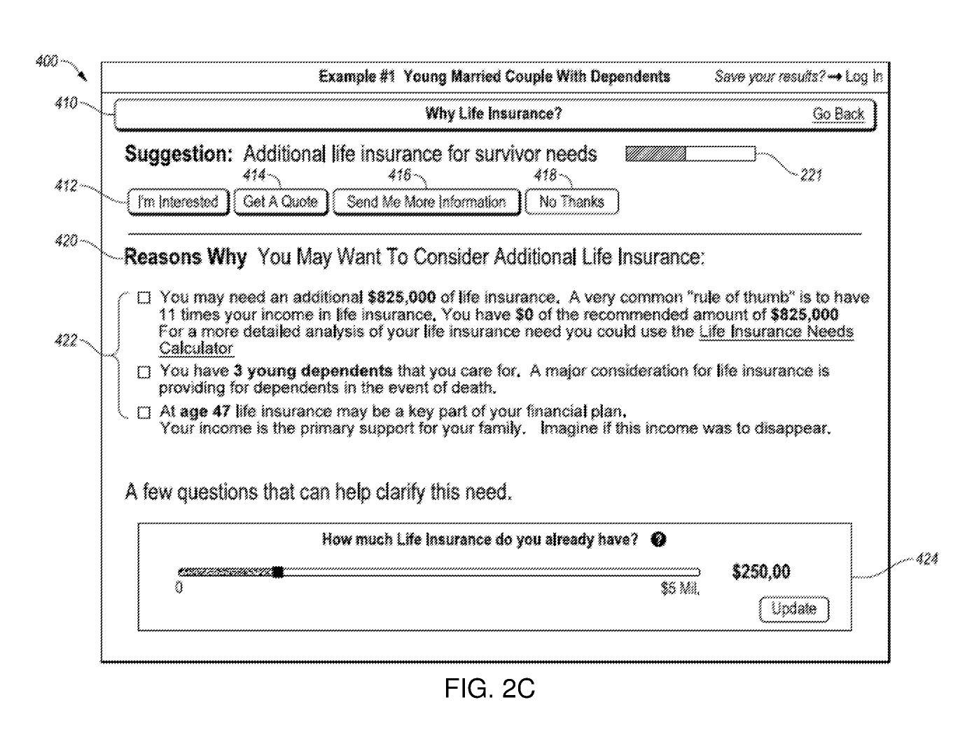

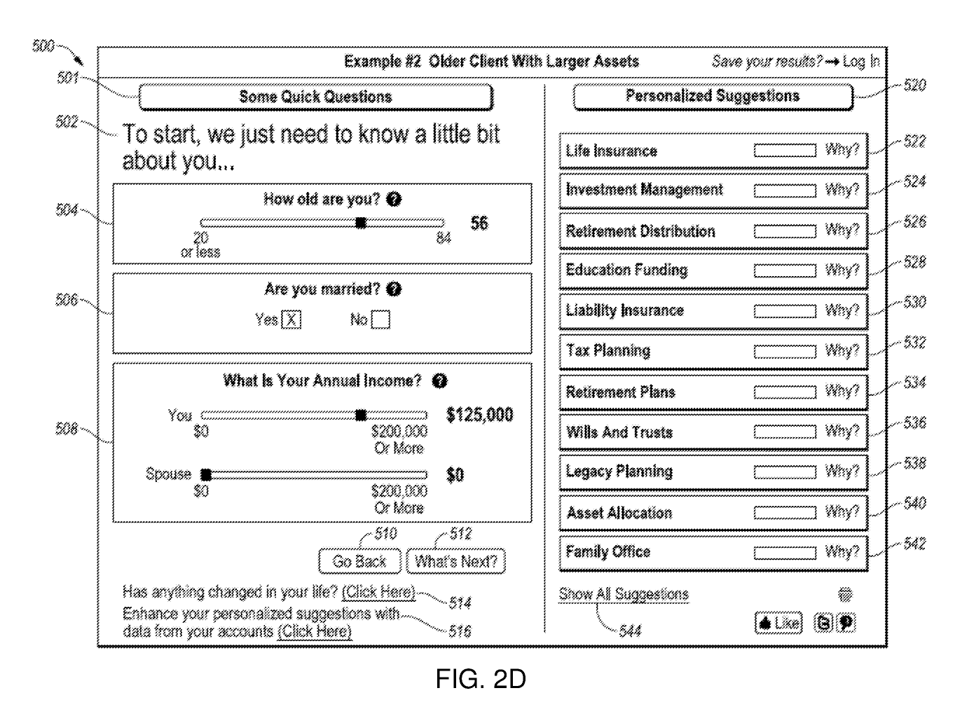

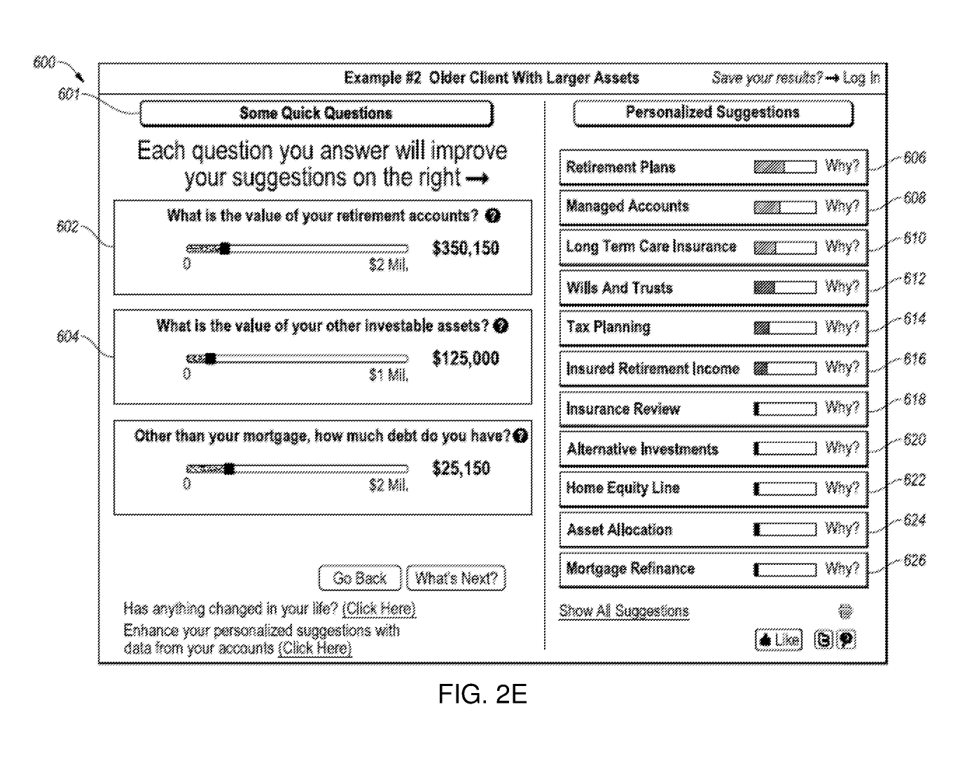

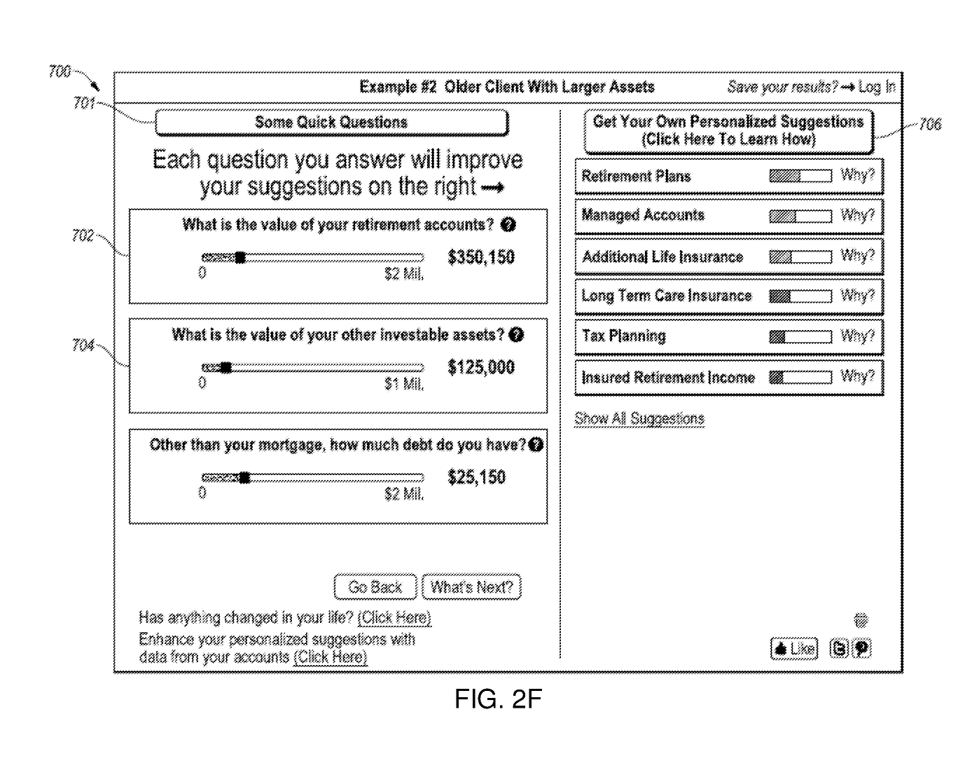

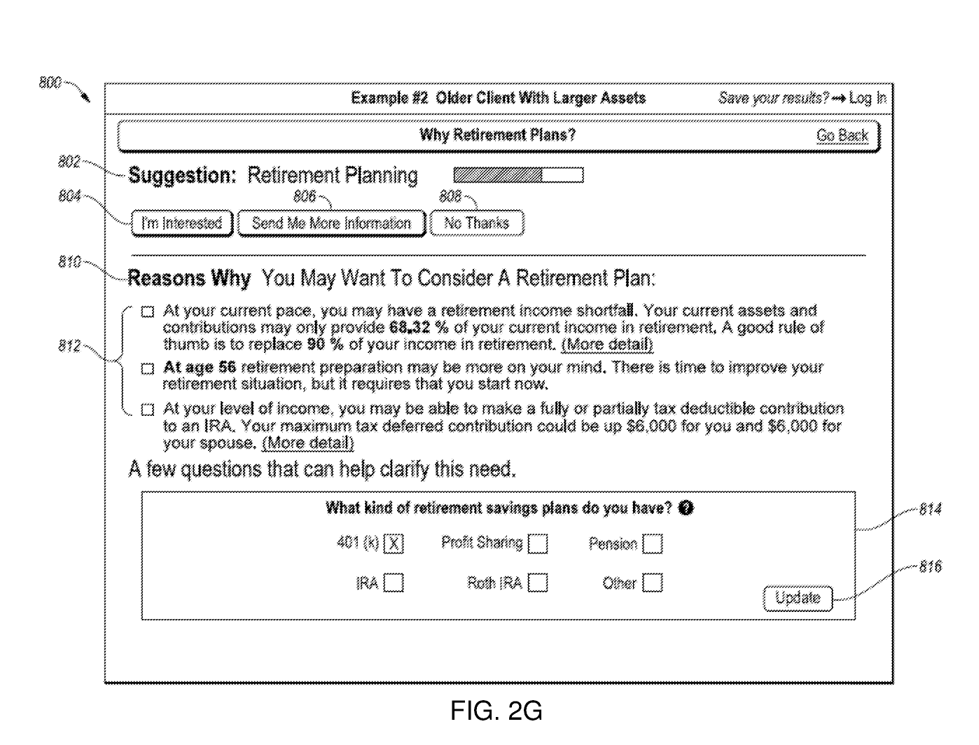

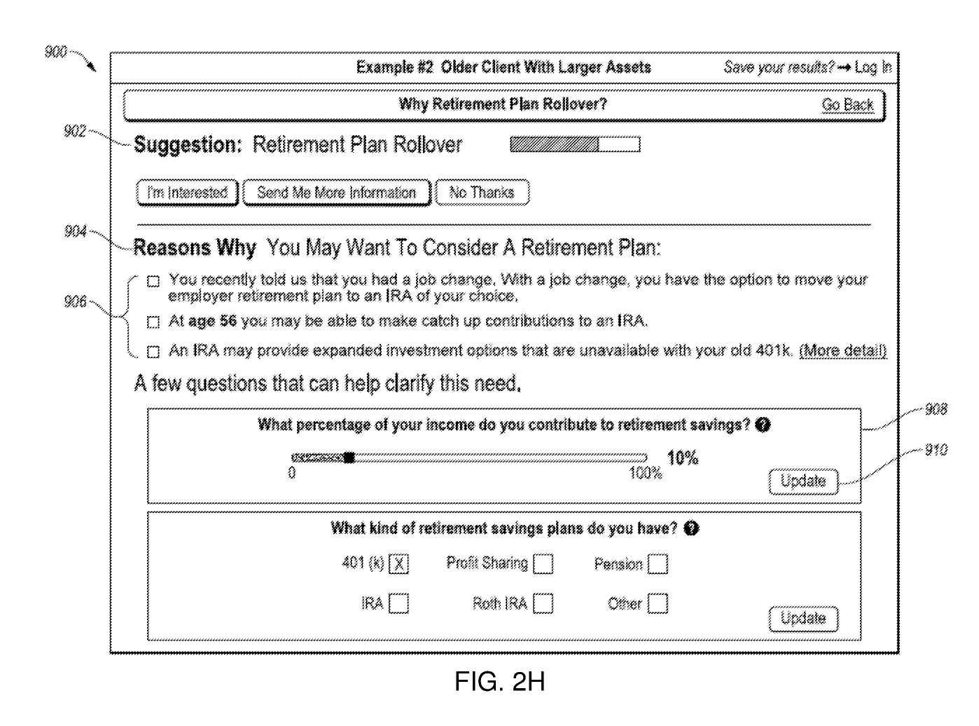

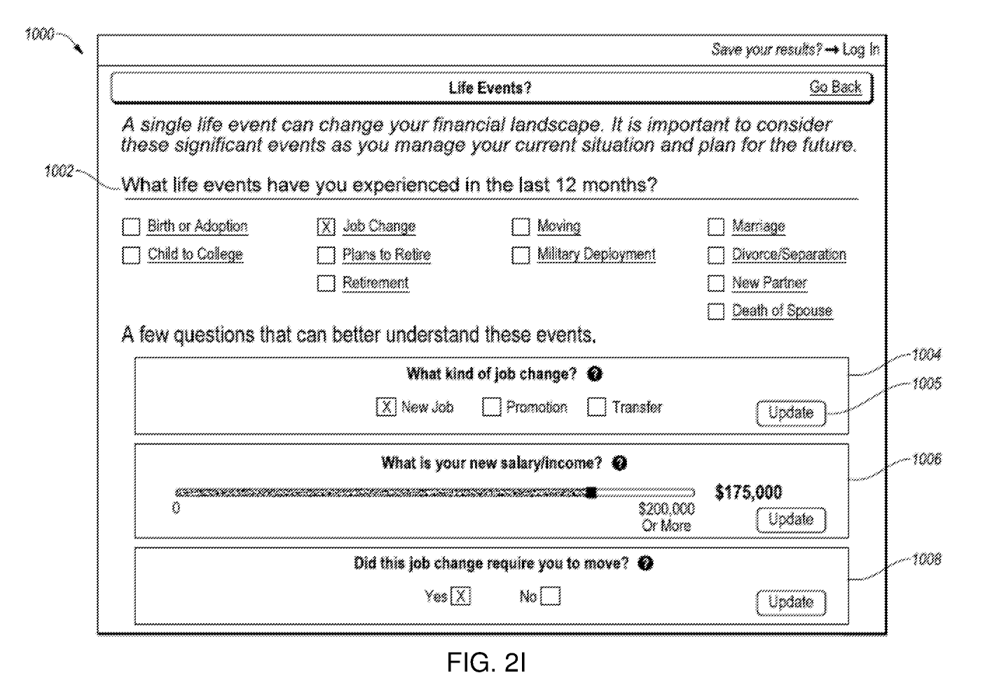

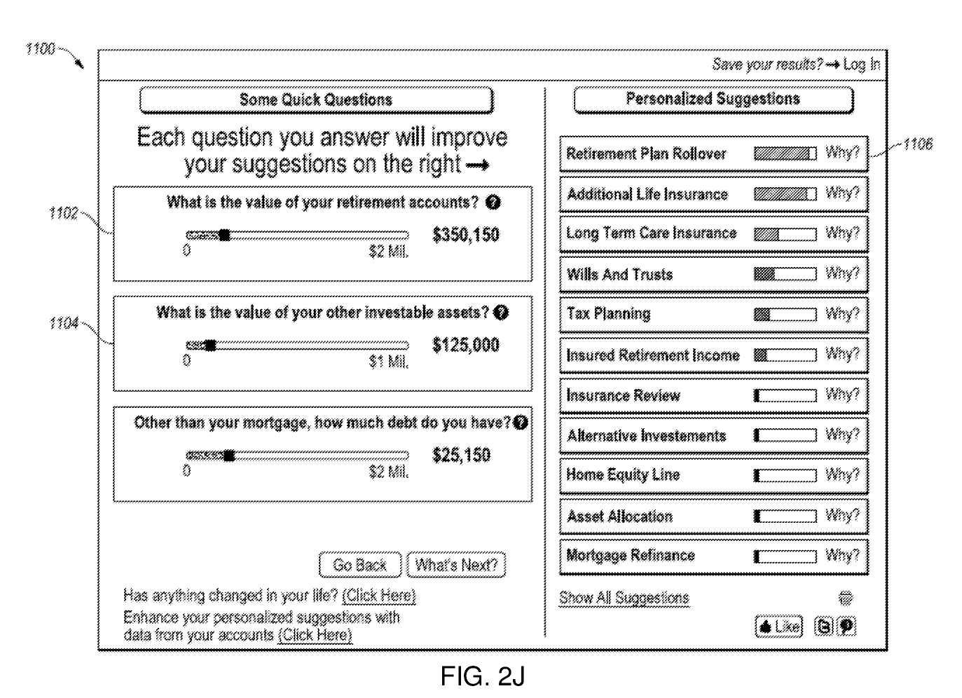

FIGS. 2A through 2J are screen shots that provide an example of the types of input and output that may be provided by the system. More specifically, FIGS. 2A-2C illustrate an example of a financial planning recommendation session that a young married couple with dependents might experience using the method and system described herein. As shown in FIG. 2A, the user(s) log into the system and are greeted with an initial series of questions 201, such as the user's age 202, marital status 204, and annual income 206. As the user enters this preliminary data, the personalized suggestions 220 on the opposing side of the screen are dynamically updated. In this example, the topics of life insurance 222, retirement plans 224, liability insurance 226, education funding 228, wills and trusts 230, tax planning 232, long term care 234, alternative investments 236, legacy planning 240, asset allocation 242, and mortgage refinance 244. Additional suggestions may also be shown by expanding the list by selecting link 246.

Upon answering the preliminary questions 201, the user may user the “what's next button” to advance to the screen or display 300 shown in FIG. 2B and throughout the session, the user may use the “go back” button to return to a previous screen to alter answers to the questions. Additionally, the system may include various social media links 248 which enable the users to share their personalized recommendations of the system to their friends or to recommend that their friends use the system for themselves.

In the display 200 shown in FIG. 2A, the personalized suggestions 220 include a graph 221 indicating the relevancy or suggested importance of the various financial planning tools. For example, because the users are a young married couple with dependents, the system preliminarily determines that it would be most advantageous or most strongly recommended for the user(s) to invest in life insurance for survivors 222.

As briefly mentioned above, after answering the preliminary questions 201 and receiving a set of preliminary recommendations, the user selects the button 252 to advance to screen 300 shown in FIG. 2B, where the user is presented with additional questions 302, 304 and 306 which request additional details pertaining to the couple's children and other assets. As described above with respect to claim 1, these questions 302, 304, and 306 are dynamic and are tailored so as to correspond to the information that the user has previously submitted. For example, because the user indicated at the previous screen that he or she was aged 45 and married, the system requests at 302 the ages and number of children that the couple have and the value of their assets, if any.

Based on the answers to the questions 302, 304, and 306, the personalized suggestions 220 are revaluated and potentially re-ranked. Each of these recommendations or suggestions also has a hyperlink 223 which the user may select in order to expand the screen to the display 400 shown in FIG. 2C. For example, upon requesting “why” the system recommends life insurance by clicking on hyperlink 223, the display 400 displays a list of “reasons why” 420 the couple may want to consider additional life insurance, which includes a list of reasons which are specific to the couple themselves 422. For example, the system may explain how much life insurance is recommended using a life insurance needs calculator based on the number of dependents, income, evaluation of the user's assets, and user age.

The recommendation engine may ask further questions 424 at this time, including requesting how much life insurance the user already has. Finally, the system may provide a feedback and/or contact section, whereby a user may indicate that they are interested 412 in obtaining more life insurance, not interested in life insurance 418, request a quote 414 or additional information 416. As described above, the system may use this information to update the recommendations and/or forward the users information to a financial consultant or other entity for more information or as a potential lead.

FIGS. 2D-2H show a second case study corresponding to an example of a session which may be experienced by a user who is older and who has larger assets than the user of FIGS. 2A-2C. Similar to the initial set of questions shown in FIG. 2A, the session begins with the display 500, where a set of preliminary questions 501 are presented to the user.

As shown in display 500, in this example the questions 504, 506 and 508 are the same questions as were presented to the user of FIGS. 2A-2C. As the user answers the questions, unranked financial planning mechanisms 522-542 of the personalized suggestions 520 section are evaluated and ranked. As described above, the user proceeds to the next section by selecting button 512 and may return to a previous screen by selecting button 510, and hyperlink 544 may be used to expand the list of available suggestions.

The system may also store the user's previous sessions with the system using a unique login such that any answers previously submitted to the system are automatically updated in the display 500. This information may be modified or changed by the user, or the user may indicate that an event has occurred which may alter the user's financial situation by selecting hyperlink 514. Further, the system may also enable the user to import financial data directly from their financial accounts using hyperlink 516.

Upon entering the answers to the preliminary questions 504, 506, and 508, and proceeding to the next section using button 512, the user is presented with a preliminary ranking of personalized suggestions 606-626. In this example, the system preliminarily determines that retirement planning 606 is most highly recommended, followed by managed accounts 608, long term care insurance 610, wills and trusts 612, tax planning 614, insured retirement income 616, insurance review 618, alternative investments 620, home equity line 622, asset allocation 624, and mortgage refinance 626.

As the user answers additional questions 602 and 604, the personalized suggestions are continuously reevaluated and re-ranked according to their relevancy to the user's specific situation.

Although the example shown in FIG. 2E contains an extensive listing of personalized suggestions, in another embodiment, the recommendation engine may only contain a subset of suggestions 706 or only those which are determined to be above a predetermined level of relevancy or recommendation level to the user. For example, in display 700, based on the answers to questions 702 and 704, the system may only present the user with the six most relevant financial planning suggestions or only those which are determined to be over a predetermined level or relevancy to the user.

FIG. 2G illustrates a display 800 which may be presented to the user upon the user requesting ‘why’ retirement plans are suggested. Similar to the specific recommendation shown in FIG. 2C with respect to the first user, in this example, retirement planning 802 is recommended based on the reasons 801 which are particularly relevant to the older client with large assets and a listing of user-specific reasons 812 are shown to the user.

As shown in FIG. 2G, this listing may also include ‘rule of thumb’ suggestions to the user. The recommendation engine may also present the user with additional questions 814 about the specifics of the user's retirement plans, if any exist. Once this information is submitted using button 816, the recommended financial planning solution may be updated based on this submitted information.

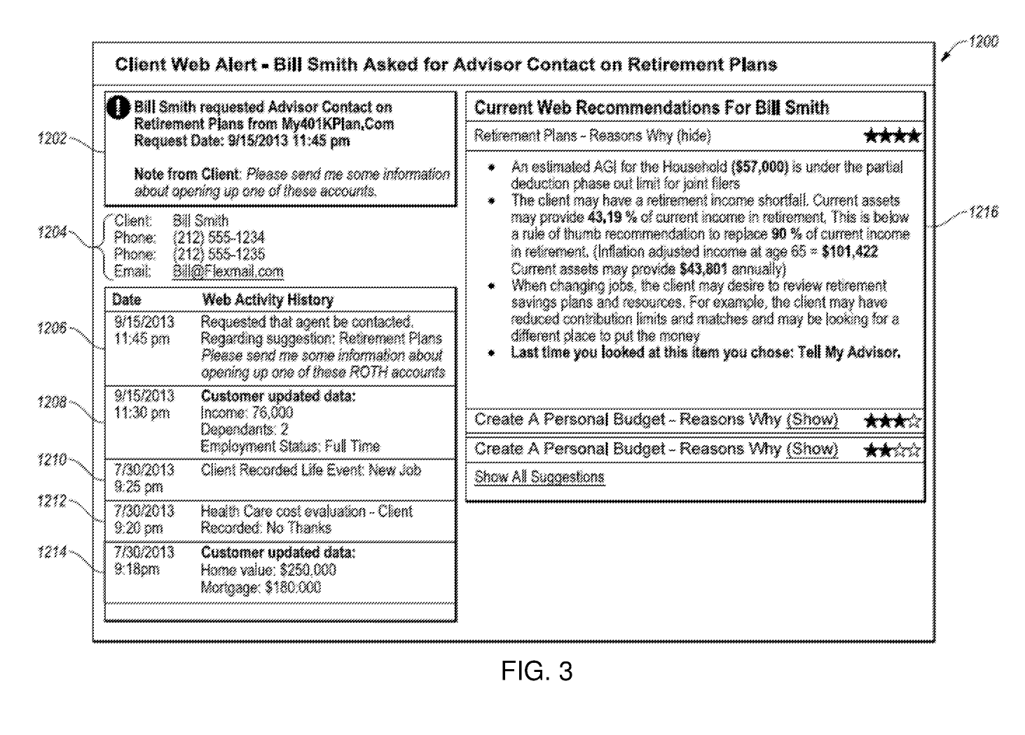

As described above, the display 800 may also include a feedback section whereby the user may indicate that he or she is interested in retirement planning, indicate that they are not interested in financial planning, and/or request more information using buttons, 804, 808, and 806, respectively. Upon receiving a request for more information using button 806, the system may send a web alert to a financial planning partner or other entity, such as will be described below with respect to FIG. 3.

FIG. 2H illustrates that additional information may be presented to the user for each of the various financial planning suggestions 902, along with additional reasons why they have been determined to be relevant to the user, with user-specific rationale 906. Further, additional questions 908 may continue to be presented which give the system an increasingly accurate portrayal of the user's current financial situation as it pertains to each of the different financial planning suggestions. The user may continue to submit this information using the tools 910 in order to receive increasingly personalized recommendations.

As described above, in some instances, the system may store a user profile which includes any information previously submitted to the system by the user and as described with respect to hyperlink 514 shown in FIG. 2D, may enable a user to submit information that relates specifically to a life changing event. FIG. 2I is a display 1000, whereby a user is able to enter information relating to the changes in life events.

As shown in FIG. 2I, the user is able to select which life events may have occurred since the user last utilized the system by selecting from a listing of common life events 1002. Once those life events have been selected, a series of relevant questions 1004, 1006, and 1008 are presented to the user for additional information. The user may then request updated recommendations based on the new events using button 1005.

Based on the new information, the system may present the user with display 1100, which now includes updated personal information and updated personalized suggestions. For example, in the display shown in FIG. 2J as compared to FIG. 2E, while the user's answers to the preliminary questions 1102 and 1104 remain unchanged, the user's new job and increased salary causes the recommendation engine to determine that a retirement plan rollover 1106 is the most pressing financial planning suggestion for the user to consider.

As may be understood by one of skill in the art, these examples of user sessions are meant to merely illustrate the various capabilities and functionality of the system and are not intended to limit the various aspects of a user interface or widget which may be used to ask the questions, receive answers from the user, and display a listing of personalized recommendations using the recommendation engine. Other features or user interfaces may be used without departing from the meaning and scope of the invention.

FIG. 3 shows an example of an electronic message that may be sent to a financial agent. In this example, an alert 1200 is sent to a party which provides or is otherwise affiliated with retirement planning. The alert may include identifying and timestamp information 1202, contact information for the user 1204 along with a listing of potentially relevant web activity 1206, 1208, 1210, 1212, 1214, which may enable the financial agent to provide more meaningful assistance and information to the user.

Further, the web alert may also provide a listing 1216 of what has already been recommended to the user along with user-specific reasons why those recommendations were made.

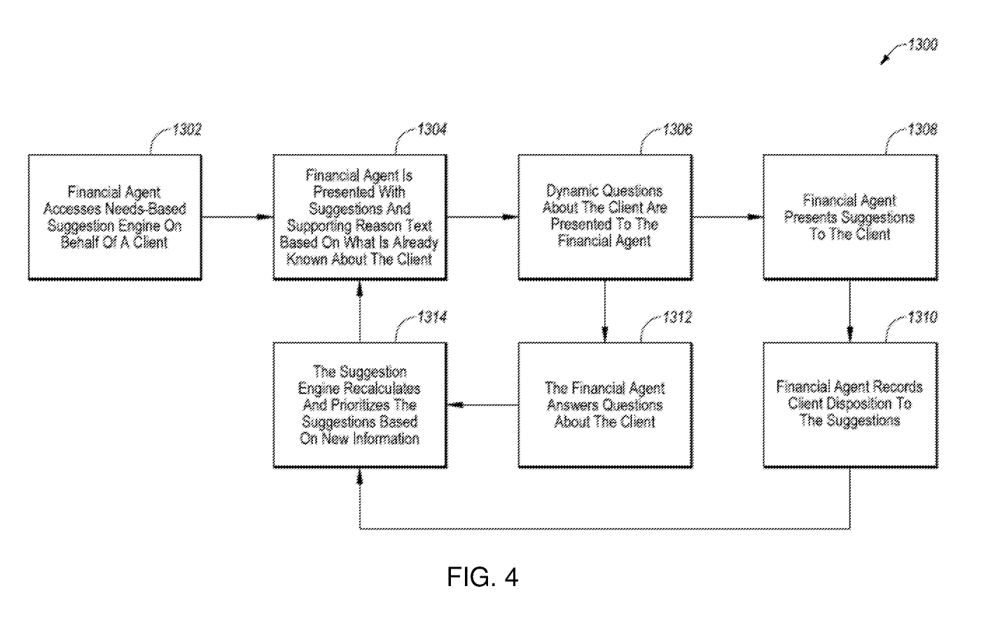

In the examples described in FIGS. 2A-2J and 3, the system is described as a widget or other user interface which may be accessed directly by the user. In an alternative embodiment shown in FIG. 4, the system may be used by a financial agent on a user's behalf. In the method 1300 shown in FIG. 4, the financial agent may access the needs based system on a user's behalf at 1302. At 1304, the financial agent is presented with suggestions and supporting reasoning and explanation based on what is already known about the client. As described above, this process may include the financial agent answering a set of preliminary questions about the client or may have submitted a preliminary set of data about the client. In another configuration, the client may have previously answered questions or submitted data about themselves. At 1306, dynamic questions about the client are presented to the financial agent. At 1312, the financial agent may opt to answer the dynamic questions about the client, causing the suggestion engine to recalculate and reprioritize the suggestions based on the newly submitted information at 1314. At 1308, the financial agent presents the suggestions to the client. At 1310, the financial agent records the client's disposition to these suggestions, and the client's disposition may then in turn be used to recalculate and reprioritize the suggestions at 1314.

Hence, the system and method described herein may be used as a part of an integrated financial recommendation system that may be used by a financial planner or an associated entity. As may be understood by one of skill in the art, the needs based system enables a financial agent to provide meaningful suggestions based on the client's specific needs while providing enough personalization so that the system may continue to adapt based on the user's continuing needs and preferences.

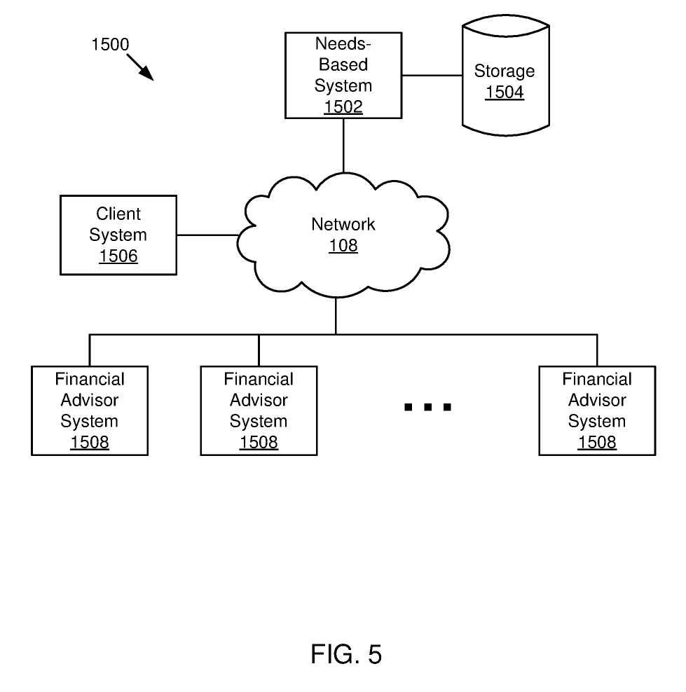

The method of providing needs-based suggestions to at least one user described herein may include requesting financial or personal information to obtain key data, analyzing key data to determine and prioritize suggestions and providing an explanation or reason for each suggestion. The method may be implemented, in whole or in part, by a processor or other processing device, such as the system described with respect to FIG. 1 or FIG. 5.

The request for the financial or personal information may include a questionnaire asking for information pertaining to the key data about the user. For example, a prompt may be provided to the user including questions about age, marital status, annual income for the individual and, if applicable, the individual's spouse. The request may also include general questions providing a link to more detailed questions that are used by the system to generate more specific questions.

Additionally or alternatively, the key data may be obtained from information associated with an online account or a personal financial management system by having the user log in to the system. If the information obtained from the account information is insufficient, one or more questions may be configured to obtain the key data. The questions may be used to determine one or more follow up questions based on answers to the previous questions, thus, minimizing the input to generate client specific suggestions.

The key data obtained from the request may be analyzed to generate and prioritize suggestions. For example, the suggestions may be ranked by a meter, numbers or stars indicating the relevance of each suggestion. As non-limiting examples, the suggestions may include retirement plans, managed accounts, long term care insurance, wills and trusts, tax panning, insured retirement income, insurance review, alternative investments, home equity line, asset allocation, mortgage refinance, and the like.

The method may further include explaining why the suggestions are recommended for the user. For example, a detailed explanation of why the suggestion was made including client specific information and calculations may be generated and provided with the suggestions.

### Department of Labor (DoL) Fiduciary Rule

In addition to providing needs based suggestion, embodiments disclosed herein may be extremely beneficial for record keeping and reporting under the new DoL Fiduciary Rule. Specifically, the DoL issued final regulations on Apr. 6, 2016 expanding the definition of fiduciary to include several investment products types previously not covered. Applicants have recognized that considerable effort in tracking, monitoring, and reporting investment advice may be required using currently available technologies and systems.

In one embodiment, the suggestions, scoring, reasoning, and other teaching provided herein may be used to generate suggestions and reasoning for recording investment advice and/or transaction histories for clients. For example, each time a suggestion is made or a product is purchased, information about the suggestion, product, and/or the reasoning may be stored. This historical information may then be used to automatically log how investment advice for the different products relates to or benefits the client and/or their specific situation. The automatic generation and storing of reasoning may significantly reduce the efforts and costs required by financial advisors and firms to meet, or prove compliance with, the fiduciary requirements of laws, regulations, or professional associations.

FIG. 5 is a schematic block diagram illustrating one embodiment of a system 1500 for generating and storing reasoning in relation to an investment or financial product. The system 1500 includes a needs-based system 1502 and storage 1504. The needs-based system 1502 may generate suggestions for financial products and reasoning explaining reasons why a specific financial product applies to a specific individual or client. The needs-based system 1502 stores the suggestions and the reasoning in the storage 1504. The needs-based system 1502 may be accessed by the client system 1506 and/or a financial advisor system 1508 via network 1510.

The needs-based system 1502 may provide suggestions, reasoning, or other information to the client system 1506 and or financial advisor system 1508 for viewing or review by a user. Additionally, the financial advisor system 1508 and or the client system 1506 may provide client details or other client parameters to the suggestion system for storage in the storage 1504 or for processing. For example, the needs-based system 1502 may use the client details or parameters to generate suggestions or reasoning. The client system 1506 may include a device or system used by a fiduciary or client, such as a laptop computer, smart phone device, desktop computer, or other computing device. The financial advisor system 1508 may include a device used by a financial advisor such as a computing device of the financial advisor or of a company providing financial services or consultation to a client.

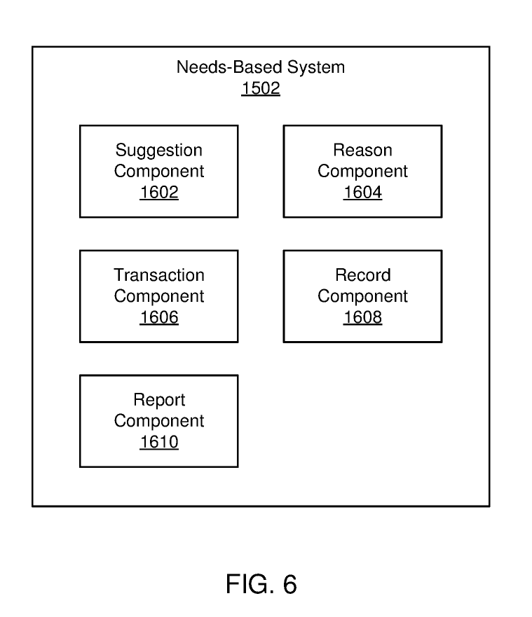

FIG. 6 is a schematic block diagram illustrating components of a suggestion system, according to one embodiment. The needs-based system 1502 includes a suggestion component 1602, a reason component 1604, a transaction component 1606, a record component 1608, and a report component 1610. The components 1602-1610 are given by way of example only and may not all be included in all embodiments. For example, each of the components 1602-1610 may be included in or may be implemented by the system 1500 or part of a separate device or system.

The suggestion component 1602 is configured to generate suggestions for financial products for a client. The suggestion component 1602 may suggest financial products such as retirement products, insurance products, investment products, annuities, or any other financial products, such as those discussed herein. The suggestion component 1602 may generate suggestions based on client data. For example, the suggestion component 1602 may generate a score for each available financial product based on the parameters about the client. The parameters may include any of the client details discussed herein, such as age, income, savings, the amounts within different investment accounts, client risk tolerance, cost of living requirements, or the like. The suggestion component 1602 may determine a suggestion for a financial product based on the scores and may determine may also provide the score with the suggestion. In one embodiment, the suggestion component 1602 may prioritize the financial products based on the score. For example, a highest score financial product may be listed first so that a client or advisor can locate the most important needs of the client.

In one embodiment, the suggestion component 1602 generates suggestions based on a plurality of rules. For example, the rules may indicate how to generate a score for a financial product based on client parameters. One or more rules may be specific to a specific type of product (e.g., term life insurance) or a specific product (term life insurance from a specific provider). In one embodiment, one or more rules are configurable by a user or firm. For example, a specific financial advisor may set up rules that dictate when specific products are suggested based on that specific financial advisor's strategy. Similarly a financial advising firm or company may also determine rules or requirements that are used to calculate a score for a financial product.

While some rules may be used to calculate a score, other rules may be used as thresholds on whether a product or product type can be suggested at all. For example, compliance rules or legal requirements for an industry may indicate that certain products or certain types of products cannot even be recommended or suggested to a client, except under certain conditions such as age or net worth. In one embodiment, similar blocking or thresholding rules may be set up by a financial advisor or firm to prevent suggestion or recommendation of products under conditions deemed inappropriate by the financial advisor or firm. Compliance rules that may be used to determine whether a client can even be recommended a product may include one or more of a firm specific compliance rule, an industry specific compliance rule, a legal requirement, and an analyst specific compliance rule.

The reason component 1604 is configured to automatically generate reasoning that explains why a specific product or a specific product type is recommended for a client. In one embodiment the reason component 1604 may generate reasoning that references one or more client info parameters of the client. For example, the reasoning may state that a certain condition of the client indicates that a specific product may benefit the client. Example reasoning for a life insurance product is shown below:
Based on what you have told us, you may have the following needs:
Your estimated insurance need: $1,130,000
Reasons why:
   The client may need an additional $1,130,000 of life insurance.
      A very common rule of thumb is to have 10 times the client's income in life insurance based on age and number of dependents (2). The client currently has $200,000 of the recommended amount of $1,330,000 leaving a shortfall of $1,130,000.
   The client has indicated that they have one dependent that is elementary school age.
      A major consideration for life insurance is providing for the needs of young dependents in the event of death.
   The client has indicated that they have one dependent that is 18 or older has moved out.
      Although dependents may have left the home, there may still be a financial obligation and responsibility in the event of the client's death.
   The client has indicated 2 needs that maybe considered “advanced”.
      The needs of Supplemental Retirement Income, Estate Equalization are considered to be more advanced needs. You may want to consider the long-term impact of these needs and increase or decrease the needed amounts accordingly. For additional help you can contact the sales desk.

Example reasoning for an estimated life insurance mix is illustrated below:
Based on what you have told us, your estimated insurance mix is:
38% lifetime/62% temporary
Reasons why:
   The client has indicated that they have one dependent that is elementary school age.
      Elementary school age children may be an indication of a very young family. Having protection for them will be of great concern especially for their need and care over time.
   The client has indicated that they have one dependant that is 18 or older that has moved out.
      Although dependents may have left the home, there may still be a financial obligation and responsibility in the event of the client's death.
   Lifetime: 38% temporary: 62%
      The rule of thumb for a client age 41 is to have 38% permanent and 62% term insurance. To be consistent with general planning best practices, the client may wish to convert some term insurance or supplement their life insurance protection with a permanent policy.
   Of the needs for insurance indicated, three are lifetime needs.
      You indicated the following lifetime needs for insurance: Final Expenses, Mortgage and Debt, Estate Equalization.
   Of the needs for insurance indicated, three are temporary needs.
      You indicated the following temporary needs for insurance: Income for Survivors Kids, Education, Supplemental Retirement Income.
   The client has indicated 2 needs that maybe considered “advanced”.
      The needs of Supplemental Retirement Income, Estate Equalization are considered to be more advanced needs. You may want to consider the long-term impact of these needs and increase or decrease amounts accordingly. For additional help, you can contact the sales desk.

Example reasoning for Indexed Universal life insurance is illustrated below:

### What is Indexed Universal Life (IUL)

Indexed Universal life is a type of permanent life insurance that offers the same features as traditional universal life but with an opportunity to earn interest linked to the performance of an indexed account (such as the S&P 500), while protecting the policies cash value from market risk. Generally, Indexed Universal Life policies have more cash value accumulation potential and other universal life products.
Pros:
   Build up cash value
   You can adjust the premiums that you pay to increase or decrease the growth of the cash value
   You can stop payments if needed if the cash value is funded sufficiently to pay for the insurance
   You can adjust the face value up or down without a new policy
   More flexible than whole life

Cons:
Universal Life is more expensive initially than term life insurance
Universal Life may lapse if you choose to pay less than guideline or no lapse premium

Reasons why:
This product maybe a primary option for 2 of the needs identified for the client.
   The needs of Kids Education, Supplemental Retirement Income may be supported by this product type. It is prudent to look at product that addresses multiple needs. Reasons for the fit: Kids Education: IUL can help provide lifetime cash for education. Term provides death benefit, Supplemental Retirement Income: cash accumulation primary focus.
This product may be a secondary option for three of the needs identified for the client.
   The needs of Final Expenses, Income for Survivors, Mortgage and Debt may be supported by this product type, however, there may be another product that supports these needs more completely.
Regarding accumulation and death benefits, the client wants a solution with Mixed Accumulation and Death Benefit. This product provides Moderate Accumulation.
   Accumulation of cash value can sometimes be a trade off with other factors such as flexibility and cost. The need for accumulation will depend on the purpose of the insurance. Certain products are better for accumulation purposes than others.
This product provides Guarantees/Limited Flexibility and the clients want a solution with The Most Flexibility.
   Review the flexibility of this product with the desires of the client. There may be multiple products that fit the needs of the client, however, they may feel more comfortable with one needs or desires for flexibility and guarantees.

The reasoning may also include tables with costs, graphs, percentages, return on investment, or the like with regard to a specific product or insurance. The reasoning may be provided to the client or financial advisor with a suggestion that a specific product or product type may meet the client's needs. For example, the reasoning may be presented before purchase or enrollment to help the client and/or financial advisor determine if the product is right for the client.

In one embodiment, the reason component 1605 may generate reasoning by retrieving template text for a financial product and modifying the template text based on the one or more client parameters. For example, the reason component 1604 may retrieve template text corresponding to a specific financial product that is stored in a database and then generate specific reasoning for the client based on client info parameters. For example, some language may be included or removed based on one or more client parameters. As another example, the reasoning may reference a net worth, insurance coverage, family state, age, or any other detail about the client to explain why a product may or may not be of benefit to the client. As yet another example, values provided within the reasoning (e.g., amount of insurance needed, the insurance mix, etc.) may be computed based on the client parameters.

The transaction component 1606 is configured to receive an indication of a transaction or suggestion involving the client. For example, the transaction component 1606 may receive an indication that a financial product has been purchased by a client or has been purchased by a financial advisor on behalf of the client. In one embodiment the transaction component 1606 may also receive an indication that a specific product has been suggested to the client. The transaction component 1606 may receive a message or indication of suggestions, purchases, or enrollments in response to the use of a suggestion system 1500 by the client or by financial advisor acting on behalf of the client. The transaction component 1606 may receive a message indicating the financial product, the product type, the product name, a date, reasoning, and/or an identifier for the client. The message may include any other information about the transaction or suggestion. In one embodiment, the transaction component 1606 generates a message including any of the related information in response to receiving an indication of the occurrence of the transaction or suggestion.

The record component 1608 is configured to store a record of the transaction or suggestion with the reasoning. The record component 1608 may store the record of the transaction or suggestion in the storage 1504. In one embodiment, the record component 1608 stores the record of the transaction with an indication of the date, the client, the financial product name, the financial product type, and the reasoning indicating why the financial product may benefit the client. In one embodiment, the record component 1608 may store all suggestions or transactions for a specific client along with reasoning and any other information about a transaction or suggestion. For example, a database may be updated to include all suggestions or transactions for the client which have been performed by a financial advisor, firm, or software on behalf of the client. These transactions or suggestions may be easily accessed for later reference for proving compliance with legal or professional requirements.

The report component 1610 is configured to generate a report of one or more products purchased or enrolled in by the client. The report component 1610 may generate a report including reasoning or any other details related to a transaction or a suggestion corresponding to the client. The report component 1610 may generate the report by retrieving records stored by the record component 1608 in the storage 1504. The report may be used to prove that a firm or financial advisory met a fiduciary requirement in assisting or counseling the client with regard to the specific suggestion or transaction.

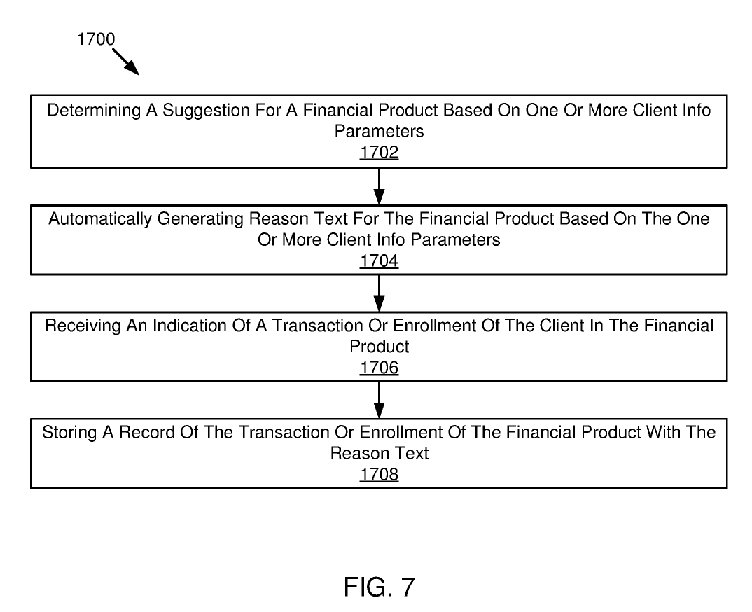

FIG. 7 is a schematic flow chart diagram illustrating an example method 1700 for logging a transaction or suggestion related to a financial product. The method 1700 may be performed by a suggestion system 1500, such as the suggestion system of FIG. 5 or 6.

The method 1700 begins and a suggestion component 1602 determines 1702 a suggestion for a financial product based on one or more client info parameters. A reason component 1604 automatically generates 1704 reasoning for the financial product based on the one or more client info parameters. The reasoning provides an explanation for why the financial product provides a benefit to the client based on the one or more client parameters. The transaction component 1606 receives 1706 an indication of a transaction or enrollment of the client in the financial product. A record component 1608 stores 1708 a record of the transaction or enrollment of the financial product with the reasoning.

### Illustrative Embodiment

The new DoL Fiduciary Rule requires that an advisor act in the best interest of a client when recommending retirement solutions. Much like you determine what type of car you want to buy before you select the make and model, acting in the client's best interest requires several steps. The first step is identifying the right product type (vehicle) and the second step is determining the right product (make and model). For example if it is determined that guaranteed income is a key part of a client's retirement plan then a specific annuity might be suggested to provide that guaranteed income.

Applicants have recognized that the DoL fiduciary rule facilitated the need for determining a mix of retirement products. In one embodiment, a scoring methodology is used to help determine which mix of retirement vehicles or products is best suited for an individual client. These suggestions are combined with text that explains why a product type fits a client's needs. A dynamic questionnaire may be used to assess risk tolerance, guarantees versus flexibility, proximity to income need, retirement income needs, etc.

The system may estimate the client's retirement needs and how the client's current assets may be able to replace that income in retirement. This “retirement income replacement” rule of thumb is then used with further analysis to determine the product solutions that may be in the client's best interest. If the client has 401k and/or IRA assets an additional analysis is conducted to analyze current fees, features, and employer contributions. A current 401k or IRA can then be compared side-by-side with a firm's IRA. The 401k rollover analysis uses both statistical data with a combination of preferential questions in the analysis. Analysis can be completed in the following areas: admin fees, management fees, fund options availability, historic returns, availability of investment advice, and insurance options (annuities and other life insurance in plan). Profiling questions to help identify factors most important to the client nay include: desire for consolidation, desire for investment advice, remaining employer benefits, desire for guaranteed income solutions, desire for additional types of investments, age, matching, employer subsidies, RMD issues.

In the product selection process the first step may be to identify the right product type and the second step is determining the specific product. Retirement product types and other needs are scored and the product types that are best suited for the client are identified. If an advisor “clicks” the “Show Details” button by each product type, text explaining the fit of the product type for the client is displayed.

Client information gathered through the dynamic questionnaire may also help to determine an allocation of income sources. This starts with a base guaranteed income need, and adjusts the amount up or down by the following client specific factors: risk tolerance, size of portfolio, proximity to retirement, liquidity needs, retirement income projection, and growth versus guarantees of income.

The system may be used to determine an appropriate strategy or combination of strategies for retirement income funding. Based on the client's information input in the questionnaire a proposed retirement income allocation is displayed. The allocation can be determined from model portfolios loaded into the retirement income profiles through parameter screens. The retirement income profiler may use a scoring methodology to help determine which type of retirement vehicles or products are best suited for an individual client. One desirable feature is the display of text explaining how a product or configuration meets the client's needs.

The system may provide support of annuities, mutual funds, ETFS, managed money accounts and life insurance solutions. Product categories can be configured to match the solutions available from a firm or company. The questionnaire may be configured with the questions relevant to the product types of a specific firm. Risk tolerance questions and scoring parameters can be configured to model the firms risk tolerance approach. The system provides retirement income needs calculations based on client age, income, retirement objectives, assets, annual savings and social security eligibility. The system provides scoring for investment vehicle and automatically provides reasoning to explain the fit of each product type to the client's needs. The system collects information on a client's current 401k and/or IRA accounts as well as the client's attitudes toward investment options and plan features and compares it to the firm's available IRA options.

If plan sponsor, fund and participant data is available through a third party aggregator, the system can interface with a third party aggregator to import the data on existing 401k and/or IRA plans. If aggregation is not supplied, users will need to manually enter required 401k and/or IRA plans data. The system produces a printed report including client data used in analysis, proposed product type allocation and recommended product types to consider for each client. Settings and parameters allows the firm's home office personnel to modify scoring as needed to meet the firm's requirements.

The system may use a sales intelligence engine to determine the relevance of specific annuities for a client's needs and objectives. The system gathers key information from clients about their preferences for income, liquidity, time horizon, source of funds (qualified assets) risk tolerance, expenses, and guarantees. The engine then configures and filters the company's inventory of available annuities and living benefit options then ranks orders those that best meet the client's objectives. The increased requirements of the new DoL fiduciary rule highlight the need to provide advisors tools that analyze annuities and suggest those annuities that are best for clients.

The system uses a systematic annuity selection process complete with compliance and suitability questions built-in to provide best interest annuity selection. Building compliance and suitability rules into the annuity selection process allows for managing a more regulated sales process. Using a systematic approach helps advisors identify the best annuities for each client and addresses the Best Interest requirement of the DoL fiduciary rule.

The selection process for annuities may become highly scrutinized and may require an unbiased systematized process complete with the data used for the analysis and an audit trail showing results. Firms may be required to demonstrate an audit-able process used in selection of annuities and disclose additional information including commissions.

With the large number of annuity products and features available from multiple insurers it can often be challenging for a financial professional to effectively focus on the carriers, products, and features that best meet the objectives and needs of an individual client. The system may help financial professionals identify the subset of products that best meet the client's objectives. Not only are the products filtered, but features such as living benefits are analyzed and presented. This ensures that the right products with the right features are evaluated and discussed with the client. The system may analyze annuities in the following five steps.

Step one, system gathers a client's information including preferences and future desires as illustrated in the fact finder. Step two, the engine determines the relevance of specific annuities from the company's inventory of available annuities. Each annuity is also evaluated, and where appropriate, each living benefit rider is evaluated based on factors such as: cost, available income at the target withdrawal, flexibility of investment options, and step ups to the benefit base. The system has the flexibility to consider the various options and calculation methods of target income. These calculations combined with the scoring component allow these complex options to be uniquely configured against the needs and preferences of the client. The configured and ranked annuities are listed on a results screen for review by a financial advisor and/or client.

Step three, a financial professional can select any of the annuities listed and is provided with detailed reasoning (automatically generated) on each annuity and rider option. The reasoning explains the calculations in terms that help the advisor quickly understand and ultimately help the advisor explain the solution to the client. Step four, a financial professional can also select to compare annuities side-by-side. Step five, a report is generated. The report captures the client data used in the analysis as well as selected annuities complete with reasoning for each annuity and a comparison chart of the annuities selected.

One highly desirable feature of embodiments disclosed herein is robust client-specific text that assists an advisor in communicating how a specific annuity and living benefit configuration meets the client's needs. The automatically generated reasoning also describes for the client and future heirs a disciplined approach used to determine suitability.

Fiduciary rules as it relates to annuity sales may require a best interest contract for the sale of both variable and fixed indexed annuities in qualified accounts. If an annuity sale also has commission, a BICE will also be required. In order to comply, advisors will have to evaluate the client's needs and determine what annuities best meet the client's objectives. Given the dozens of carriers and hundreds of products selecting an annuity product for a client that meets the new regulation can be a daunting task.

Applicants believe that the increased requirements highlight the need for tools that analyze annuities and suggest those annuities that are best for their clients. Embodiments disclosed herein may use a sales intelligence engine to determine the relevance of specific annuities for a client's needs and objectives.

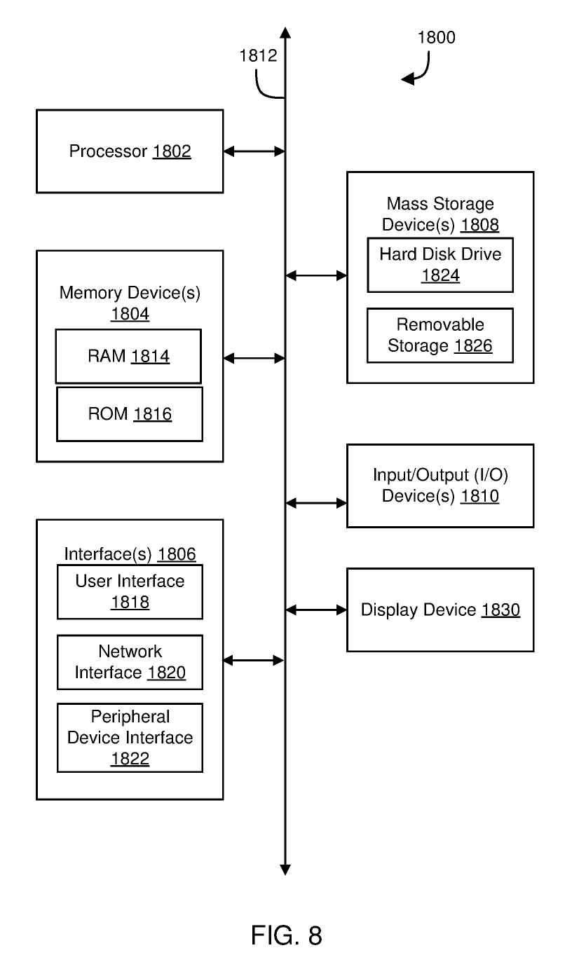

Referring now to FIG. 8, a block diagram of an example computing device 1800 is illustrated. Computing device 1800 may be used to perform various procedures, such as those discussed herein. Computing device 1800 can function as a system, computer, or other computing device as disclosed herein. Computing device 1800 can perform various functions as discussed herein, such as the generation of suggestions, reasoning, or other processing functionality described herein. Computing device 1800 can be any of a wide variety of computing devices, such as a desktop computer, web server, a notebook computer, a handheld computer, tablet computer and the like.

Computing device 1800 includes one or more processor(s) 1802, one or more memory device(s) 1804, one or more interface(s) 1806, one or more mass storage device(s) 1808, one or more Input/Output (I/O) device(s) 1810, and a display device 1830 all of which are coupled to a bus 1812. Processor(s) 1802 include one or more processors or controllers that execute instructions stored in memory device(s) 1804 and/or mass storage device(s) 1808. Processor(s) 1802 may also include various types of computer-readable media, such as cache memory.

Memory device(s) 1804 include various computer-readable media, such as volatile memory (e.g., random access memory (RAM) 1814) and/or nonvolatile memory (e.g., read-only memory (ROM) 1816). Memory device(s) 1804 may also include rewritable ROM, such as Flash memory.

Mass storage device(s) 1808 include various computer readable media, such as magnetic tapes, magnetic disks, optical disks, solid-state memory (e.g., Flash memory), and so forth. As shown in FIG. 8, a particular mass storage device is a hard disk drive 1824. Various drives may also be included in mass storage device(s) 1808 to enable reading from and/or writing to the various computer readable media. Mass storage device(s) 1808 include removable media 1826 and/or non-removable media.

I/O device(s) 1810 include various devices that allow data and/or other information to be input to or retrieved from computing device 1800. Example I/O device(s) 1810 include cursor control devices, keyboards, keypads, microphones, monitors or other display devices, speakers, printers, network interface cards, modems, and the like.

Display device 1830 includes any type of device capable of displaying information to one or more users of computing device 1800. Examples of display device 1830 include a monitor, display terminal, video projection device, and the like.

Interface(s) 1806 include various interfaces that allow computing device 1800 to interact with other systems, devices, or computing environments. Example interface(s) 1806 may include any number of different network interfaces 1820, such as interfaces to local area networks (LANs), wide area networks (WANs), wireless networks, and the Internet. Other interface(s) include user interface 1818 and peripheral device interface 1822. The interface(s) 1806 may also include one or more user interface elements 1818. The interface(s) 1806 may also include one or more peripheral interfaces such as interfaces for printers, pointing devices (mice, track pad, or any suitable user interface now known to those of ordinary skill in the field, or later discovered), keyboards, and the like.

Bus 1812 allows processor(s) 1802, memory device(s) 1804, interface(s) 1806, mass storage device(s) 1808, and I/O device(s) 1810 to communicate with one another, as well as other devices or components coupled to bus 1812. Bus 1812 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 1800, and are executed by processor(s) 1802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is a system that includes a suggestion component configured to determine a suggestion for a financial product based on one or more client info parameters. The a system includes a reason component configured to automatically generate reasoning for the financial product based on the one or more client info parameters, wherein the reasoning provides an explanation for why the financial product provides a benefit to the client based on the one or more client parameters. The system includes a transaction component configured to receive an indication of a transaction or enrollment of the client in the financial product. The system includes a record component configured to store a record of the transaction or enrollment of the financial product with the reasoning.

In Example 2, the suggestion component as in Example 1 is configured to display the suggestion for the financial product to a user.

In Example 3, the reason component as in any of Examples 1-2 is configured to generate reasoning including reasoning that references the one or more client info parameters.

In Example 4, the reason component as in any of Examples 1-3 is configured to generate reasoning by retrieving template text for the financial product and modifying the template text based on the one or more client parameters.

In Example 5, the system as in any of Examples 1-4 further includes a report component configured to generate a report of one or more products purchased or enrolled in by a client, wherein the report includes the reasoning for each product of the one or more products.

In Example 6, the suggestion component as in any of Examples 1-5 is configured to generate suggestions based on a plurality of rules.

In Example 7, the plurality of rules as in Example 6 include one or more compliance rules, wherein the suggestion component determines the suggestion for the financial product based on one or more of the financial product and the one or more client info parameters meeting a requirement of the one or more compliance rules.

In Example 8, the compliance rules as in Example 7 include one or more of a firm specific compliance rule, an industry specific compliance rule, a legal requirement, and an analyst specific compliance rule.

Example 9 is a method that includes determining a suggestion for a financial product based on one or more client info parameters. The method includes automatically generating reasoning for the financial product based on the one or more client info parameters, wherein the reasoning provides an explanation for why the financial product provides a benefit to the client based on the one or more client parameters. The method includes receiving an indication of a transaction or enrollment of the client in the financial product. The method includes storing a record of the transaction or enrollment of the financial product with the reasoning.

In Example 10, the method of Example 9 further includes providing the suggestion for the financial product for display to a user.

In Example 11, automatically generating reasoning as in any of Examples 9-10 includes automatically generating reasoning including reasoning that references the one or more client info parameters.

In Example 12, automatically generating reasoning includes as in any of Examples 9-11 includes retrieving template text for the financial product and modifying the template text based on the one or more client parameters.

In Example 13, the method as in any of Examples 9-12 further includes generating a report of one or more products purchased or enrolled in by a client, wherein the report includes the reasoning for each product of the one or more products.

In Example 14, determining the suggestion as in any of Examples 9-13 includes determining based on a plurality of rules.

In Example 15, the plurality of rules as in Example 14 include one or more compliance rules, wherein determining the suggestion includes determining the suggestion for the financial product based on one or more of the financial product or the one or more client info parameters meeting a requirement of the one or more compliance rules.

In Example 16, the compliance rules of Example 15 include one or more of a firm specific compliance rule, an industry specific compliance rule, a legal requirement, and an analyst specific compliance rule.

Example 17 is computer readable storage media storing instructions that, when executed by one or more processors, cause the one or more processors to determine a suggestion for a financial product based on one or more client info parameters. The instructions cause the one or more processors to automatically generate reasoning for the financial product based on the one or more client info parameters, wherein the reasoning provides an explanation for why the financial product provides a benefit to the client based on the one or more client parameters. The instructions cause the one or more processors to receive an indication of a transaction or enrollment of the client in the financial product. The instructions cause the one or more processors to store a record of the transaction or enrollment of the financial product with the reasoning.

In Example 18, the computer readable storage media of Example 16 further includes instructions that cause the one or more processors to display the suggestion for the financial product to a user.

In Example 19, the instructions of any of Examples 17-18 cause the one or more processors to generate reasoning by retrieving template text for the financial product and modifying the template text based on the one or more client parameters.

In Example 20, the computer readable media as in any of Examples 1-19 further include instructions that cause the one or more processors to generate a report of one or more products that have been suggested to a client, purchased by the client, or enrolled in by the client, wherein the report includes the reasoning for each product of the one or more products.

Example 21 is an apparatus including means to perform a method or realize a system or apparatus as in any of Examples 1-20.

Example 22 is a machine readable storage including machine-readable instructions, when executed, to implement a method or realize an apparatus of any of Examples 41-57.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

1. A system comprising:
a suggestion component configured to determine a suggestion for a financial product based on one or more client info parameters;
a reason component configured to automatically generate reasoning for the financial product based on the one or more client info parameters, wherein the reasoning provides an explanation for why the financial product provides a benefit to the client based on the one or more client parameters;
a transaction component configured to receive an indication of a transaction or enrollment of the client in the financial product; and
a record component configured to store a record of the transaction or enrollment of the financial product with the reasoning.

2. The system of claim 1, wherein the suggestion component is configured to display the suggestion for the financial product to a user.

3. The system of claim 1, wherein the reason component is configured to generate reasoning comprising reasoning that references the one or more client info parameters.

4. The system of claim 1, wherein the reason component is configured to generate reasoning by: retrieving template text for the financial product; and modifying the template text based on the one or more client parameters.

5. The system of claim 1, further comprising a report component configured to generate a report of one or more products purchased or enrolled in by a client, wherein the report includes the reasoning for each product of the one or more products.

6. The system of claim 1, wherein the suggestion component is configured to generate suggestions based on a plurality of rules.

7. The system of claim 6, wherein the plurality of rules comprise one or more compliance rules, wherein the suggestion component determines the suggestion for the financial product based on one or more of the financial product and the one or more client info parameters meeting a requirement of the one or more compliance rules.

8. The system of claim 7, wherein the compliance rules comprise one or more of:
a firm specific compliance rule;
an industry specific compliance rule;
a legal requirement; and
an analyst specific compliance rule.

9. A method comprising:
determining a suggestion for a financial product based on one or more client info parameters;
automatically generating reasoning for the financial product based on the one or more client info parameters, wherein the reasoning provides an explanation for why the financial product provides a benefit to the client based on the one or more client parameters;
receiving an indication of a transaction or enrollment of the client in the financial product; and
storing a record of the transaction or enrollment of the financial product with the reasoning.

10. The method of claim 9, further comprising providing the suggestion for the financial product for display to a user.

11. The method of claim 9, wherein automatically generating reasoning comprises automatically generating reasoning comprising reasoning that references the one or more client info parameters.

12. The method of claim 9, wherein automatically generating reasoning comprises:
retrieving template text for the financial product; and
modifying the template text based on the one or more client parameters.

13. The method of claim 9, further comprising generating a report of one or more products purchased or enrolled in by a client, wherein the report includes the reasoning for each product of the one or more products.

14. The system of claim 9, wherein determining the suggestion comprises determining based on a plurality of rules.

15. The method of claim 14, wherein the plurality of rules comprise one or more compliance rules, wherein determining the suggestion comprises determining the suggestion for the financial product based on one or more of the financial product or the one or more client info parameters meeting a requirement of the one or more compliance rules.

16. The method of claim 15, wherein the compliance rules comprise one or more of:
a firm specific compliance rule;
an industry specific compliance rule;
a legal requirement; and
an analyst specific compliance rule.

17. Computer readable storage media storing instructions that, when executed by one or more processors, cause the one or more processors to:
determine a suggestion for a financial product based on one or more client info parameters;
automatically generate reasoning for the financial product based on the one or more client info parameters, wherein the reasoning provides an explanation for why the financial product provides a benefit to the client based on the one or more client parameters;
receive an indication of a transaction or enrollment of the client in the financial product; and
store a record of the transaction or enrollment of the financial product with the reasoning.

18. The computer readable storage media of claim 16, further comprising instructions that cause the one or more processors to display the suggestion for the financial product to a user.

19. The system of claim 1, wherein the reason component is configured to generate reasoning by: retrieving template text for the financial product; and modifying the template text based on the one or more client parameters.

20. The system of claim 1, further comprising a report component configured to generate a report of one or more products that have been suggested to a client, purchased by the client, or enrolled in by the client, wherein the report includes the reasoning for each product of the one or more products.
